(19) United States
(12) Patent Application Publication
(10) Pub. No.: US 2015/0197965 A1
(43) Pub. Date: Jul. 16, 2015

(54) Blue Field Express Door Opener (BFXDO)

(71) Applicant: Luiz Alberto Custodio, Wilton Manors, FL (US)

(72) Inventor: Luiz Alberto Custodio, Wilton Manors, FL (US)

(21) Appl. No.: 14/030,963

(22) Filed: Jan. 15, 2014

(51) Int. Cl. E05B 81/12; B60R 16/023

(52) U.S. Cl. CPC E05B 81/12; B60R 16/023

(57) ABSTRACT

The purpose of this invention is to provide a means for the system to disengage the doors of the vehicle when the motorist accidentally leaves the child in the car with the key locked inside of the vehicle. This system also provides a bypass to attach to the key ring. Once you place your hand in front of the windshield in close proximity to the sensor switch on the dashboard, the doors will automatically disengage via the electronic module when the child is seated on the child seat. If the motorist does not have a child seat, the electronic module will send a signal to the bypass on the key ring and disengage the doors of the vehicle.

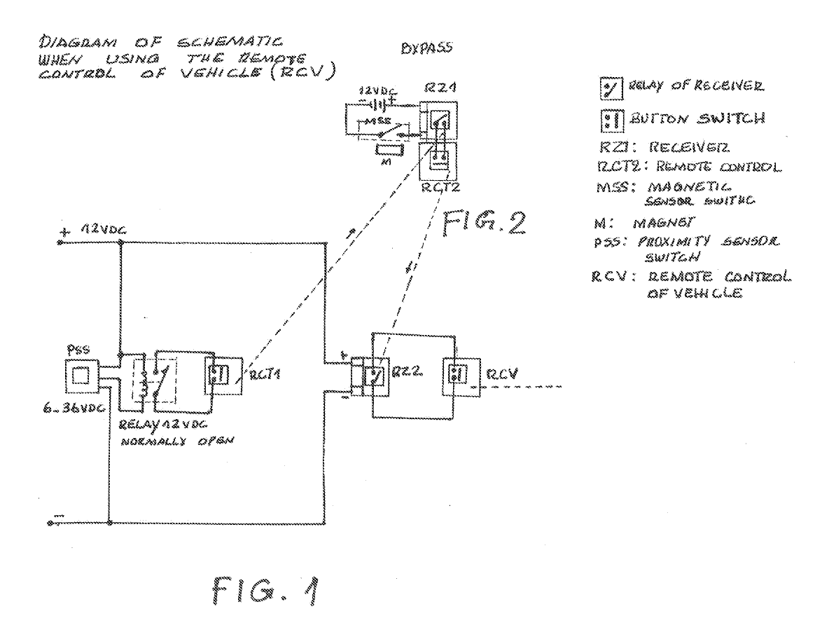

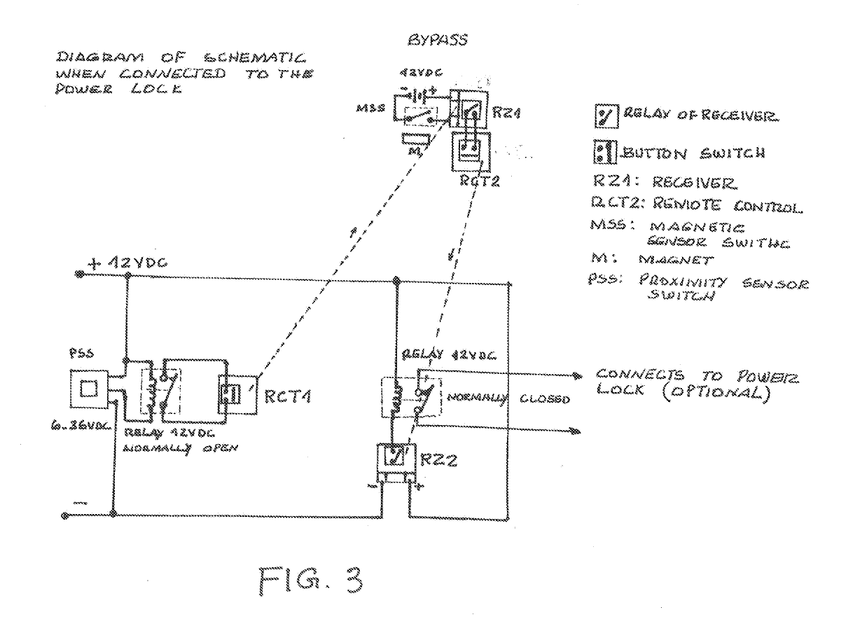

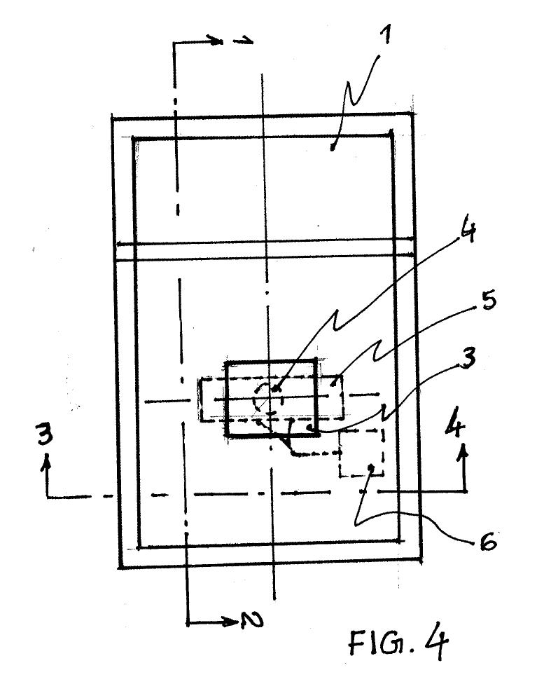

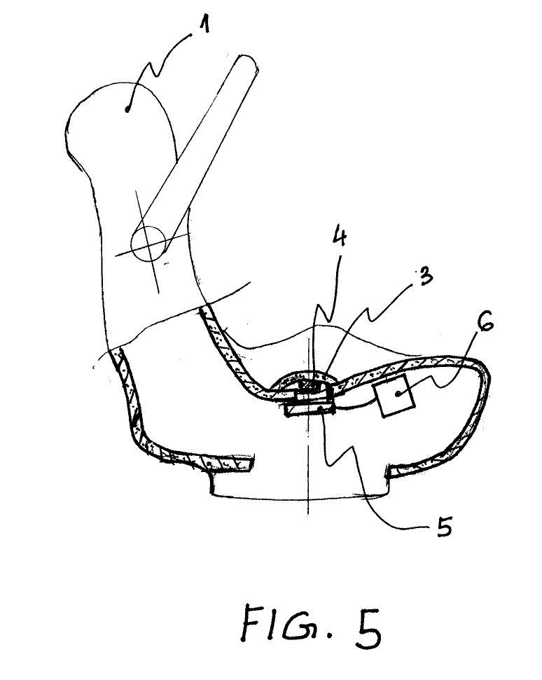

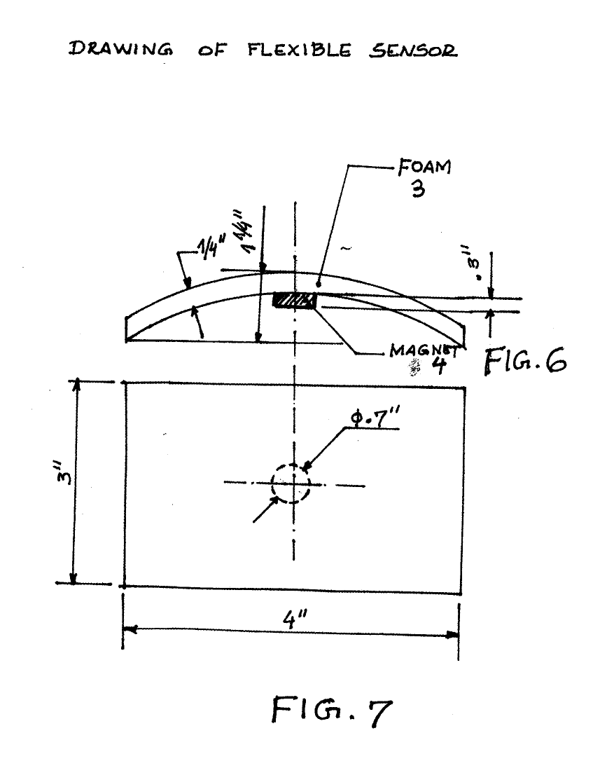

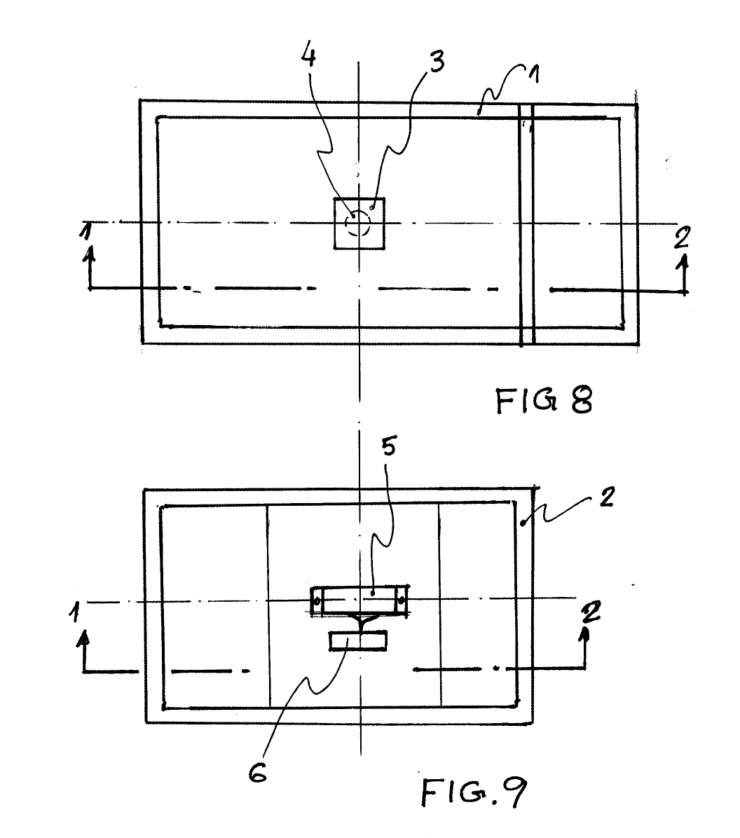

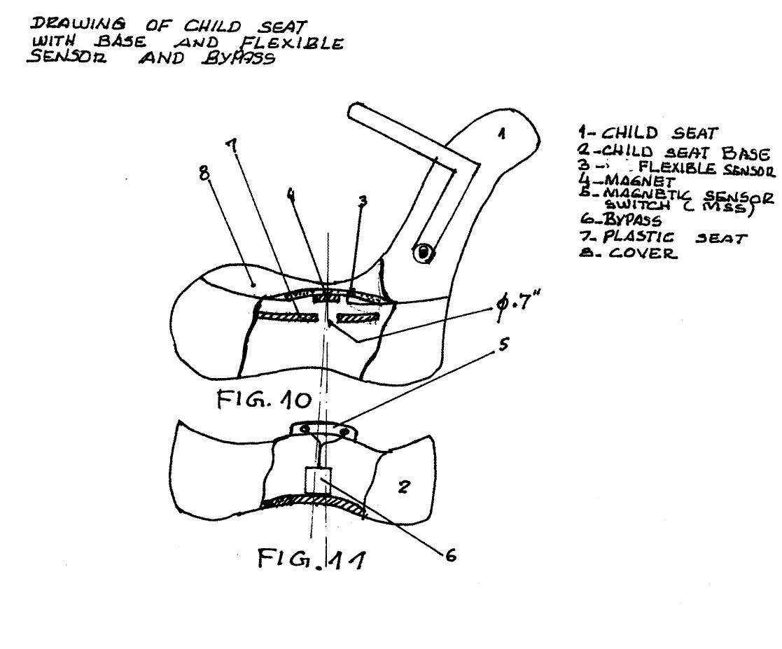

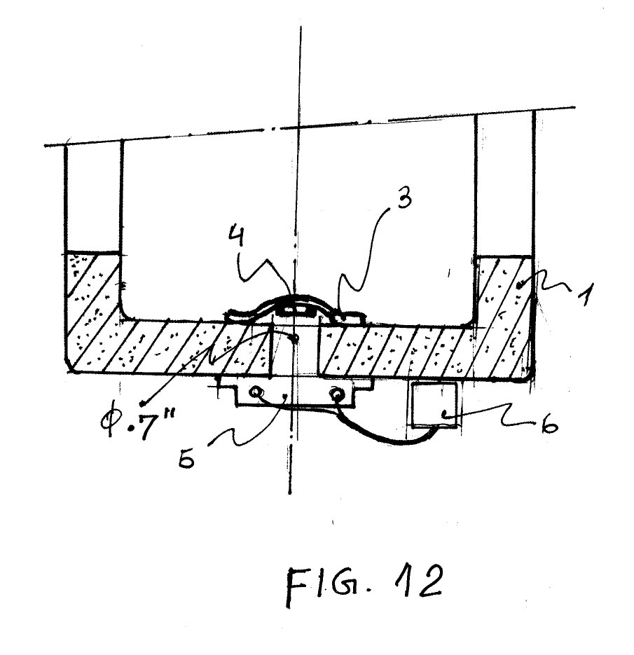

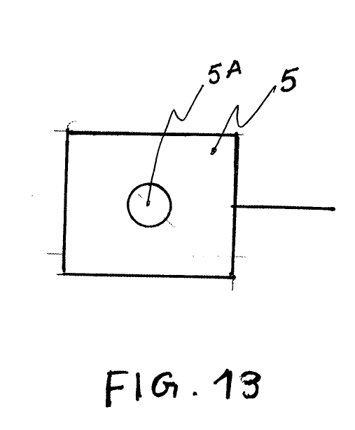

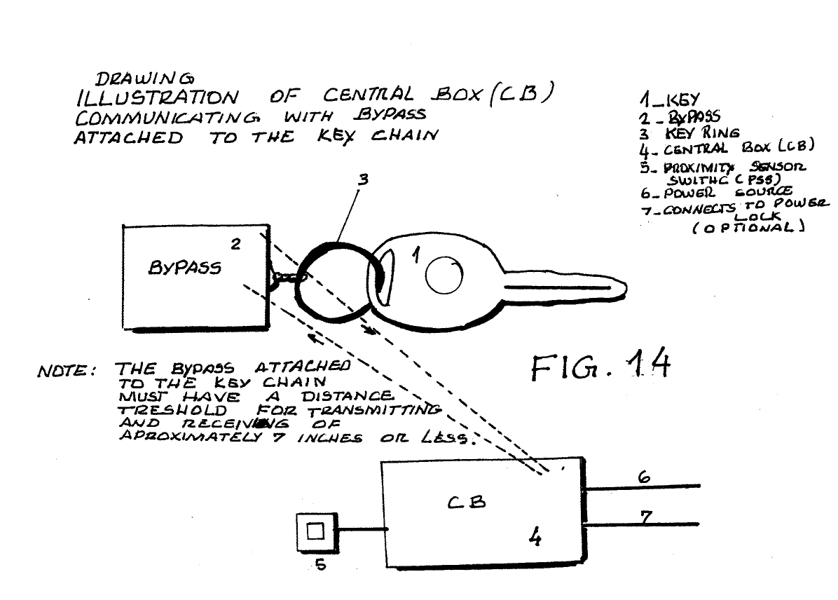

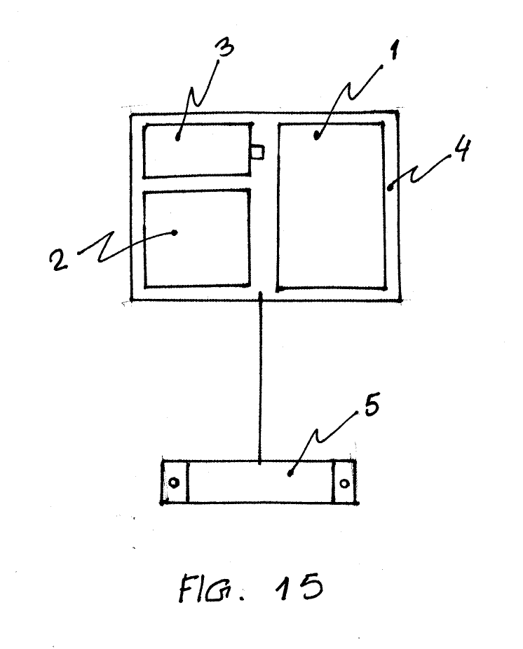

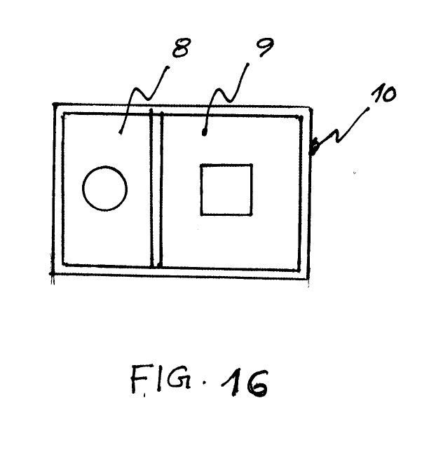

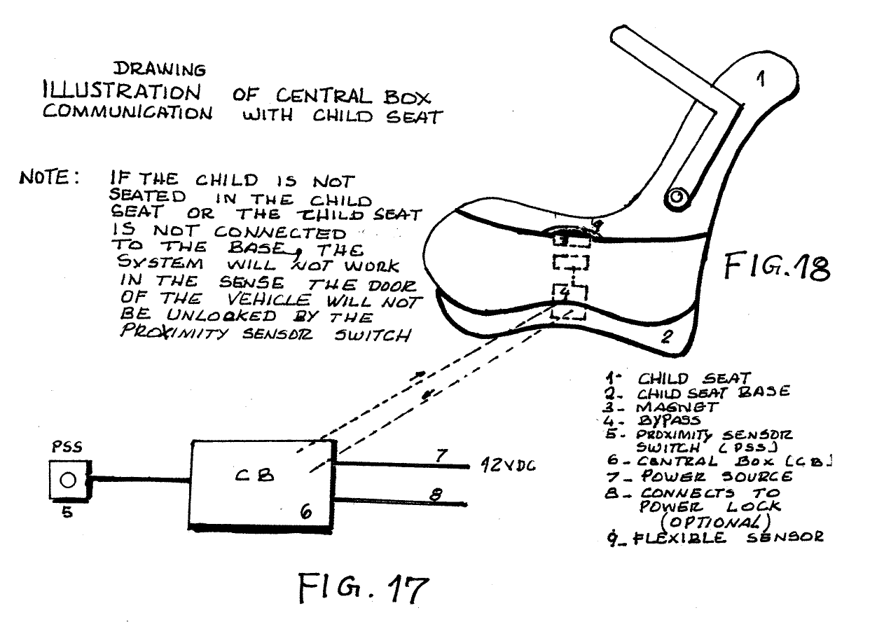

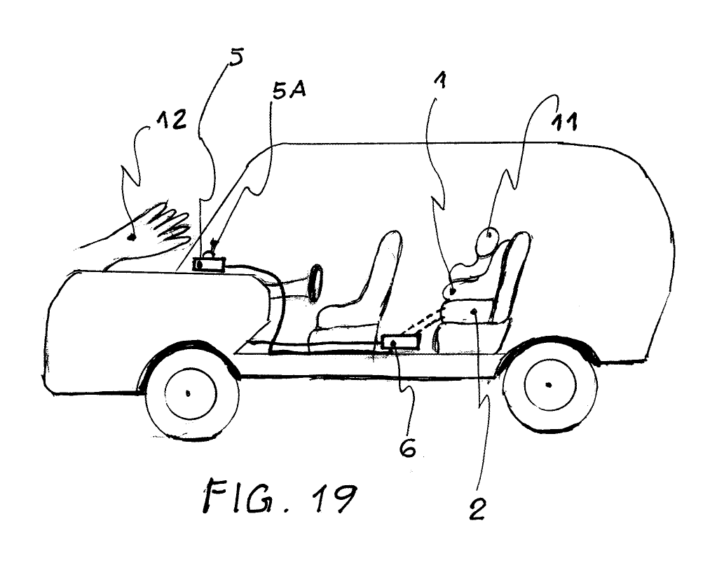

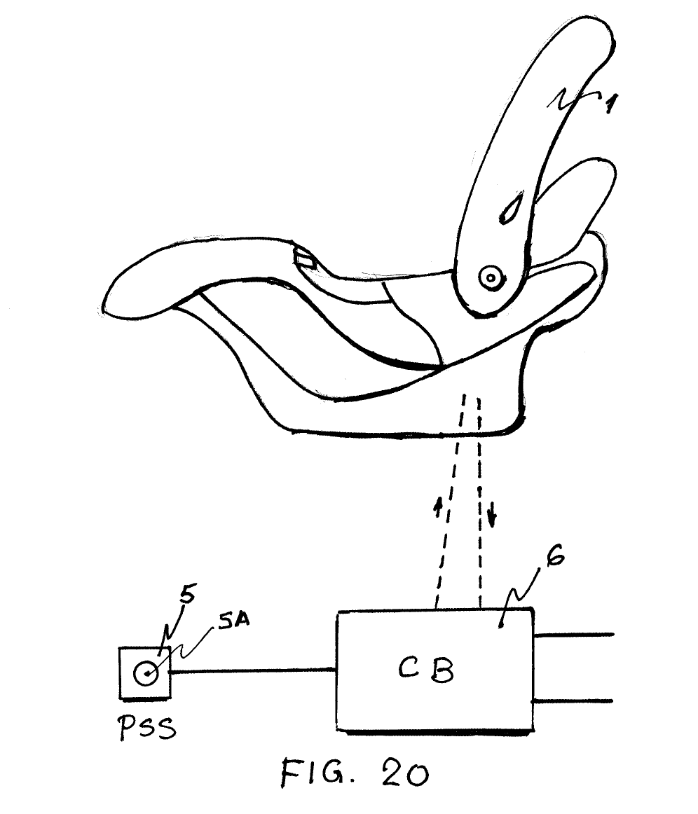

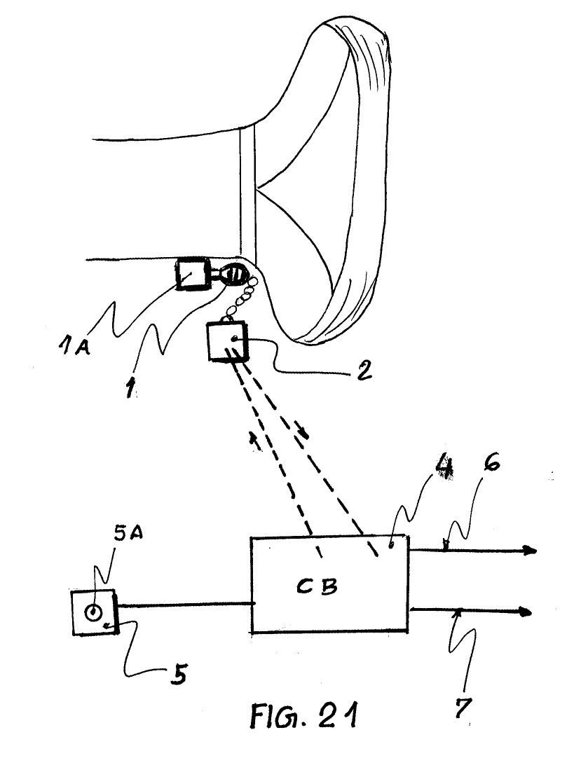

### DESCRIPTION OF NEW INVENTION

### Features:

1. To prevent children ranging in age from a newborn to three years old from being accidentally locked inside of a vehicle.

2. For when the driver simply forgets the key in the vehicle.

Profile of System: One (1) proximity sensor switch (PSS) is located on the vehicle dashboard connected to the central box (CB) and one bypass is located in the child seat with a flexible sensor interfaced with a magnetic sensor switch (MSS).
WARNING: If your hand is in front of the PSS the vehicle doors will be disengaged only if the child is seated in the child seat.

### HOW THE BLUE FIELD XDO SYSTEM WORKS

When you place your hand in front of the windshield at an approximate distance of three inches away from the proximity sensor switch (PSS) located inside of the vehicle dashboard, one relay inside the central box (CB) connects with the remote control transmitter (RCT1) followed immediately with a connection to the bypass receiver (RZ1). The bypass receiver will then automatically connect itself to the remote control transmitter (RCT2).

When RCT2 receives the transmission, it will send the signal to the RZ2 receiver located in the central box (CB). When the RZ2 receiver receives the signal from RCT2, it connects with the proper remote control of vehicle (RCV) or the power lock system.

### HOW THE SYSTEM BYPASS ATTACHED TO THE CHILD SEAT WORKS

The bypass is located in the child seat base connected with one magnetic sensor switch (MSS) and one magnetic flexible sensor (MFS) located in the child seat.

When the child sits on the child seat, the magnetic flexible sensor will connect itself to the magnetic sensor switch (MSS) at an approximate 1¼ inches.

### HOW THE SYSTEM BYPASS ATTACHED TO THE VEHICLE KEY CHAIN WORKS

When using the bypass attached to the vehicle key chain, the magnetic sensor switch will not be used. Receiver RZ1 and remote control transmitter RCT2 are both located inside the key chain enclosure. Please see the drawing illustrating this operation mode.

NOTE: When the child does not need to use the base for the child seat, the bypass will be located underneath the child seat.

### DEFENSE OF INVENTION

Have you ever experienced those moments when the door of your vehicle accidentally locks and you have forgotten the keys inside it? Or perhaps you are locked and in a hurry and do not know what to do?

Now there is a way to open your vehicle's door without use of any tools and more importantly no damages in the form of a scratch to the vehicle. I introduce to you a new product that can be installed inside of the vehicle. That product is the Blue Field XDO.

The Blue Field XDO was invented, designed, and tested in a way that the owner or installer of the system can easily adapt it to the vehicle.

The Blue Field XDO system was invented with two (2) primary objectives in mind:
1. To prevent children ranging in age from a newborn to three years old from being accidentally locked inside of a vehicle.
2. For when the driver simply forgets the key in the vehicle.

This system is efficient when needed in an extreme emergency especially when the need arises to rescue a baby trapped inside of a vehicle. As it is common for people to have baby seats in the backseat of the car, the ability to open the vehicle is made possible through the Blue Field XDO Bypass system. The Blue Field XDO Bypass system has also been designed to be canied on your key chain.

With this system installed in the vehicle all that the motorist has to do is to move in front of the windshield, place the hand in front of the sensor that will be found on the dashboard and the door will immediately be unlocked. This system was conceived through my experience and observation of how people behave on a day-to-day basis when they enter and exit their vehicles.

When a parent or someone leaves a baby in the baby seat and many times close all of the doors with the key inside the vehicle, the child inside the car will accidentally press the lock button on the wireless remote, thus engaging the car alarm system and locking all of the doors.

### CONCLUSION OF INVENTION

For the many vehicles that have key codes in the form of numbers programmed into the vehicle's door-entry system, many vehicle owners may forget or do not have the necessary code to input into the master door control panel. Furthermore, the vehicle may be used by someone other than the owner and that person may not have with him or her, or not know what the entry code for the vehicle is, thus preventing access into the vehicle. The person who is locked out of the vehicle would not have to attempt to get a hold of the owner of the vehicle for the combination code to gain access to the vehicle in situations when the owner may not be available when called.

### FEATURES

1. Can be used to open the door of a vehicle when the door is locked with a baby inside of the car. The bypass on the child seat base will be used to open the vehicle door.

2. When the motorist forgets the key inside the vehicle the door will be able to be opened with the bypass attached to the vehicle key chain.

3. When a motorist drives a car with a baby inside and gets into an accident, the firefighters will benefit from the door being opened in the event that the motorist has died or tainted while saving the baby if necessary.

4. Use for older children with physical deficiencies and are unable to move while on the child seat.

I claim:

1. In an electronic system of the type comprising a plurality of electronic devices located in an electronic central box whereby children in age ranging from a newborn to three years will not be locked inside of a vehicle. Said electronic system can optionally be connected to the remote control of vehicle or the power locking system. power locking system.
a. A proximity sensor switch of said electronic system of claim 1 wherein said proximity sensor switch is disposed in vehicle dashboard.
b. An electronic central box that serves as the perimeter of the system electronic brain.
c. At least two relays to support the transmitters and receivers of the bypass and the electronic central box.
d. A child seat with the bypass device for sending a signal to the electronic central box remote control transmitter of claim 2.
e. A child seat base of claim 2 contiguous to child seat so that the proximity sensor switch can trigger the unlocking of the vehicle doors as pressure is urged on said child seat.

2. The proximity sensor switch wherein activated by motion of hand in front of it, activates a relay connected to the primary remote control transmitter of electronic system of claim 1, thereby sending a signal to the bypass receiver that is contiguous to the child seat. Said bypass receiver will then activate the secondary remote control transmitter to send a signal to the secondary receiver disposed in the electronic central box, thereby unlocking the vehicle doors.

3. The electronic system wherein said bypass of claim 2 whereby children of said age range described in claim 1 will not be locked inside of a vehicle.
a. A bypass of the type described in claim 2 that is disposed to said child seat base as described in claim 1.
b. A magnetic sensor switch disposed to said child seat of claim 3 that becomes contiguous to the magnetic flexible sensor disposed to said child seat base upon the urging of pressure on said child seat by the child.

4. The electronic system wherein said bypass of claim 3 that is disposed to the child seat of claim 3 and incorporates a bypass on the vehicle key chain so that when it is desired not to use the child seat base. In such instance whereby the child seat base is not used, said bypass will be disposed thereunder said child seat.
a. A bypass as described in claim 3 that is attached to the vehicle key chain.
b. A transmitter and a receiver both disposed in said vehicle key chain that thereby communicates with electronic central box to unlock vehicle doors.

5. A method of unlocking the vehicle car doors, compromising:
25. (a) providing an electronic system of the type to unlock vehicle doors comprising of a plurality of electronic components that will communicate with each other in a series of transmissions and receptions,
26. (b) providing an electronic system to unlock vehicle doors using said child seat and child seat base without the need to connect the system to the vehicle power door locking system,
27. (c) whereby an electronic system includes a means to unlock vehicle doors using said child seat and child seat base without the need to connect the system to the remote control of the vehicle or the power locking system.
